(19) United States
(12) Patent Application Publication
(10) Pub. No.: US 2009/0158950 A1
(43) Pub. Date: Jun. 25, 2009

(54) METHOD AND APPARATUS FOR RE-REGISTERING A MECHANICAL DRIVE PRESS

(75) Inventors: Richard Dale Lewis, Windham, NH (US); John DeCarlo, Chester, NH (US); James E. Lewis, Falmouth, NH (US)

Correspondence Address: MESMER & DELEAULT, PLLC, 1 NEW HAMPSHIRE AVE., SUITE 125, PORTSMOUTH, NH, 03801, US

(73) Assignee: CC1 INC., Portsmouth, NH (US)

(21) Appl. No.: 12/296,520

(22) PCT Filed: Apr. 10, 2007
(86) PCT No.: PCT/IB2007/051287

§ 371 Date: Oct. 8, 2008

Related U.S. Application Data
(60) Provisional application No. 60/744,537, filed on Apr. 10, 2006.

(51) Int. Cl. B41F 1/34

(52) U.S. Cl. 101/481

(57) ABSTRACT

A method of re-registering a press job after disturbing the setup having the steps of recalling phase and compensator positions previously stored for the job; positioning compensators (113-116) to their nominal position; re-phasing the press color cylinders for the job; rerouting a web (117) through the press for the job; determining new phase offsets by running the press for a minimum of one revolution; and comparing a distance offset between adjacent print operations, thereby confirming the distance is zero and the press is back in register for the job.

### BACKGROUND

1. Field of the Invention

The invention is in the field of control systems for printing presses.

2. Description of the Related Art

In web offset printing presses, a substrate such as a web of paper is sequentially driven through a series of print cylinders, each cylinder using ink of a different color, which cooperates to imprint a multicolor image on the web. To provide an accurate and clear multicolor image, the rotational and lateral position of each print cylinder must be precisely aligned, i.e., proper color registration of the respective colors must be maintained.

Most printing presses use three basic subtractive primary colors: yellow, magenta, cyan and black to create a printed image. Special print colors can also be utilized. There are several reasons why the print may not be in register after being disturbed. The most important being that when a new job is run, it is very difficult to accurately replace the print cylinders to exactly the same position they were in when the job was last optimally run. Additionally, during the course of a run, a print cylinder may need to be replaced for defective or print change reasons. Replacing the print cylinders in exactly the same phase as before the press was stopped is very difficult and not practically achieved in the press room. A second job may need to be performed in the middle of a first job. Inks may need to be changed. Mechanical breakdown can occur. It is therefore important to accurately re-register the press as efficiently as possible.

In practice, the accurate re-engagement of a print cylinder to obtain the exact same phase and therefore minimal register error for a particular web path is very difficult and seldom possible. What results is the generation of substantial amounts of waste as the press is run and brought into register by the operator and/or automatic register control systems. What is needed, therefore, is a re-registration method and apparatus for a mechanical drive press that reduces waste to an absolute minimum.

### SUMMARY

The invention is a method and apparatus that satisfies the need to reduces waste from re-registering the press to an absolute minimum. The method of the present invention has the steps of recalling phase and compensator positions previously stored for the job; positioning compensators to their nominal position; re-phasing the press color cylinders for the job; rerouting a web through the press for the job; determining new phase offsets by running the press for a minimum of one revolution; and comparing a distance offset between adjacent print operations, thereby confirming the distance is zero and the press is back in register for the job.

An apparatus according to the present invention has a press encoder coupled to a drive shaft adapted to provide a pulse train to count position; a color cylinder proximity sensor coupled to each color cylinder to provide a single index pulse per revolution of the cylinder; a compensator position sensor; and a computer operatively coupled to each encoder, sensor, and compensator. These and other features, aspects, and advantages of the present invention will become better understood with reference to the following description, drawings, and claims.

### BRIEF DESCRIPTION OF DRAWINGS

FIG. 1 is a side elevation of a press with associated equipment.

FIG. 2 is a side elevation of the press of FIG. 1 in greater detail and without the web.

FIG. 2A is a graph displaying encoder and index signals.

FIG. 3 is a side elevation of the press of FIG. 1 in greater detail and without the web.

FIG. 3A is a graph displaying encoder and index signals.

FIG. 4 is a side elevation of another embodiment of the present invention.

FIG. 5 is a side elevation of another embodiment of the present invention.

FIG. 6 is a side elevation of another embodiment of the present invention.

FIG. 7 is a side elevation of another embodiment of the present invention.

FIG. 8 is a side elevation of another embodiment of the present invention.

FIG. 9 is a side elevation of a compensator between two rollers in three positions.

FIG. 10 is a process flow chart of the method of the present invention.

TABLE OF REFERENCES

| Number | Description |
|---|---|
| 101 | print unit |
| 102 | print unit |
| 103 | print unit |
| 104 | print unit |
| 105 | print cylinder gap for proximity sensor |
| 106 | print cylinder gap for proximity sensor |
| 107 | print cylinder gap for proximity sensor |
| 108 | print cylinder gap for proximity sensor |
| 109 | proximity sensor |
| 110 | proximity sensor |
| 111 | proximity sensor |
| 112 | proximity sensor |
| 113 | web compensator |
| 114 | web compensator |
| 115 | web compensator |
| 116 | web compensator |
| 117 | web, e.g. paper |
| 118 | main drive encoder |
| 119 | folder |
| 120 | proximity sensor |
| 121 | stud for proximity sensor on folder |
| 122 | knife cylinder for folder |
| 123 | main drive shaft |
| 124 | computer |
| 201 | print unit |
| 202 | print unit |
| 203 | print cylinder gap for proximity sensor |
| 204 | print cylinder gap for proximity sensor |
| 205 | proximity sensor |
| 206 | proximity sensor |
| 207 | web compensator |
| 208 | main drive shaft |
| 209 | main drive encoder |
| 210 | count pulse signal on main encoder |
| 211 | index pulse signal on main encoder (folder encoder) |
| 212 | proximity sensor signal from gap on print cylinder 203 and 205 |
| 213 | proximity sensor signal from gap on print cylinder 204 and 206 |
| 301 | print unit |
| 302 | print unit |
| 303 | print cylinder gap for proximity sensor |
| 304 | print cylinder gap for proximity sensor |
| 305 | proximity sensor |
| 306 | proximity sensor |
| 307 | web compensator |
| 308 | main drive shaft |
| 309 | main drive encoder |
| 310 | count pulse signal on main encoder |
| 311 | index pulse signal on main encoder (folder encoder) |
| 312 | proximity sensor signal from gap on print cylinder 303 and 305 |
| 313 | proximity sensor signal from gap on print cylinder 304 and 306 |
| 401 | print unit |
| 402 | print unit |
| 403 | print cylinder gap for proximity sensor |
| 404 | print cylinder gap for proximity sensor |
| 405 | proximity sensor |
| 406 | proximity sensor |
| 407 | web compensator |
| 408 | web compensator |
| 409 | main drive shaft |
| 410 | main drive encoder |
| 411 | web |
| 412 | print unit |
| 413 | print cylinder gap for proximity sensor |
| 414 | proximity sensor |
| 501 | print unit |
| 502 | print unit |
| 503 | print cylinder gap for proximity sensor |
| 504 | print cylinder gap for proximity sensor |
| 505 | proximity sensor |
| 506 | proximity sensor |
| 507 | web compensator |
| 508 | web compensator |
| 509 | main drive shaft |
| 510 | main drive encoder |
| 511 | web |
| 601 | print unit |
| 602 | print unit |
| 603 | print cylinder gap for proximity sensor |
| 604 | print cylinder gap for proximity sensor |
| 605 | proximity sensor |
| 606 | proximity sensor |
| 607 | web compensator |
| 608 | web compensator |
| 609 | main drive shaft |
| 610 | main drive encoder |
| 611 | string (from string encoder) |
| 612 | string anchor tie off |
| 613 | string encoder |
| 701 | print unit |
| 702 | print unit |
| 703 | print cylinder gap for proximity sensor |
| 704 | print cylinder gap for proximity sensor |
| 705 | proximity sensor |
| 706 | proximity sensor |
| 707 | web compensator |
| 708 | web compensator |
| 709 | main drive shaft |
| 710 | main drive encoder |
| 711 | string (from string encoder) |
| 712 | string anchor tie off |
| 713 | string encoder |
| 801 | print unit |
| 802 | print unit |
| 803 | print unit |
| 804 | print unit |
| 805 | print cylinder gap for proximity sensor |
| 806 | print cylinder gap for proximity sensor |
| 807 | print cylinder gap for proximity sensor |
| 808 | print cylinder gap for proximity sensor |
| 809 | proximity sensor |
| 810 | proximity sensor |
| 811 | proximity sensor |
| 812 | proximity sensor |
| 813 | web compensator |
| 814 | web compensator |
| 815 | web compensator |
| 816 | web compensator |
| 817 | web, e.g. paper |
| 818 | main drive encoder |
| 819 | folder |
| 820 | proximity sensor |
| 821 | stud for proximity sensor on folder |
| 822 | knife cylinder for folder |
| 823 | main drive shaft |
| 901 | motor/encoder assembly |
| 902 | compensator cylinder in extended position |
| 903 | compensator cylinder in center position |
| 904 | compensator cylinder in retracted position |
| 905 | web support cylinder |
| 906 | web support cylinder |
| 907 | coupler from motor/encoder shaft to threaded screw |
| 908 | threaded screw |
| 909 | web |
| 1001 | modify press |
| 1003 | bring press into register manually |
| 1005 | store press state |
| 1007 | press disturbed |
| 1009 | reset to nominal positions |
| 1011 | rotate one revolution and take measurements |
| 1013 | adjust compensators for distance offset |

### DETAILED DESCRIPTION

### I. Overview

A press with single drive shaft performs operations on a continuous moving web at multiple points. Each operation at each point must be in phase or register with all other operations taking place in the overall process. Described herein is a method and apparatus for putting all the operations in phase with a maximum of one revolution on the operation with the slowest period relative to the drive shaft.

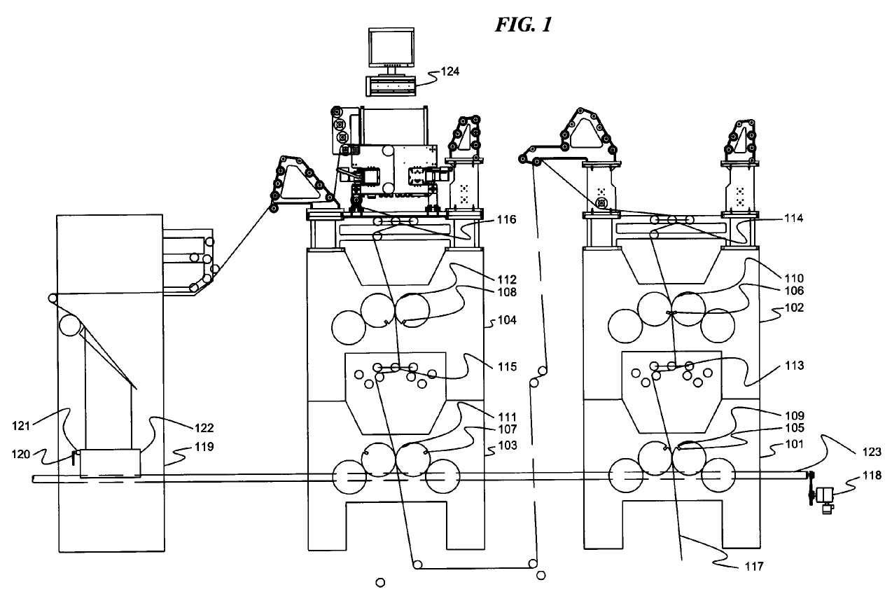

For the purposes of this specification, this method and apparatus of re-registration will be illustrated using the example of a simple newspaper web printing press, although it is applicable to any multi-color web press. FIG. 1 shows a simplified overall view of a four-color perfecting press with folder 119 and drive shaft 123. All color print cylinders are mechanically linked to the drive shaft 123 and are adjusted by means of motorized web compensators 113, 114, 115, 116 or circumferential adjustment motors to control their relative phase to the other print cylinders. The overall phase of the print to the fold is controlled by a motorized compensator that adds or subtracts from the total web lead going into the folder 119.

In steady state, in-register operation, the phase of each print cylinder relative to the drive shaft 123 will be constant. If one or more of the color cylinders are disengaged or removed from the drive shaft 123 to change the print work and then reinstalled such that the phase between the disengaged/removed cylinder and the drive shaft 123 changes, the final print work will no longer be in register. Additionally, normal operation of the newspaper press entails routing the paper 117 (web) in different paths and disengaging and re-engaging the print cylinders to a new phase relationship to the drive shaft 123 depending on the type of job being run.

### II. Phase Restoration of Color Print Cylinders Relative to the Drive Shaft

To accurately re-phase each of the color cylinders to the drive shaft for a particular web path, the printing press must have the following modifications made:

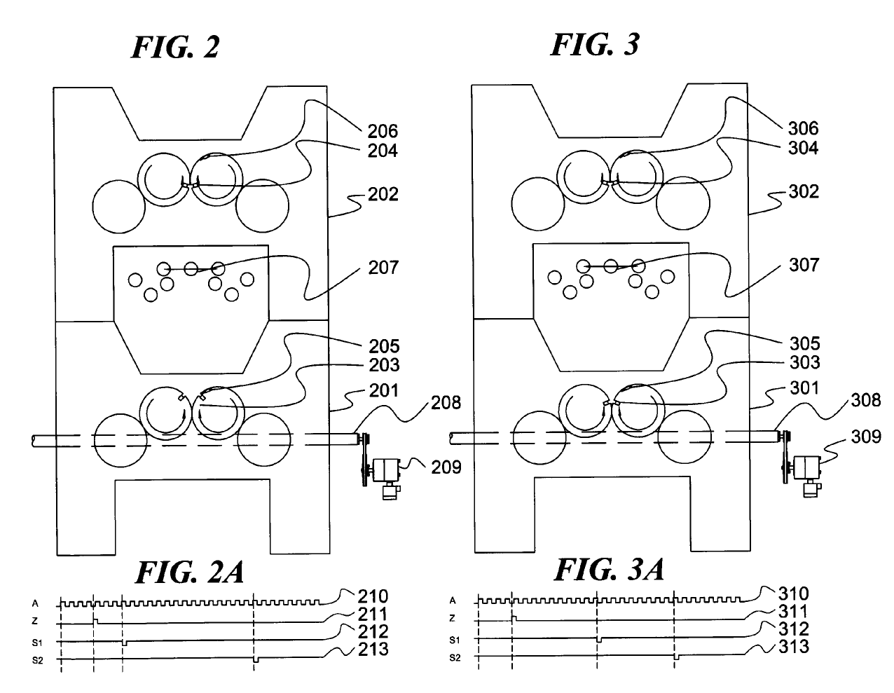

1) An encoder 118 is attached to the drive shaft 123 providing a nominal resolution of 4096 pulses per revolution 210 of the drive shaft 123, 208 and an index pulse 211 providing one pulse per revolution as shown in FIGS. 1 and 2.

2) A proximity sensor 205, 206, 305, 306 or equivalent device that is known to those having skill in the art providing one pulse per revolution 211, 311 is attached to each of the color cylinders as shown in FIGS. 2 and 3.

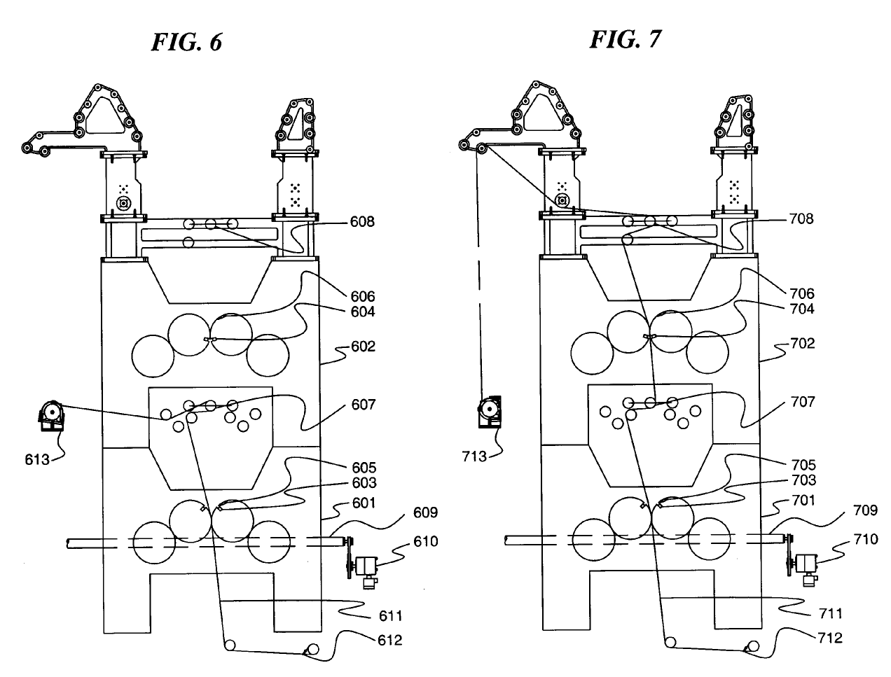

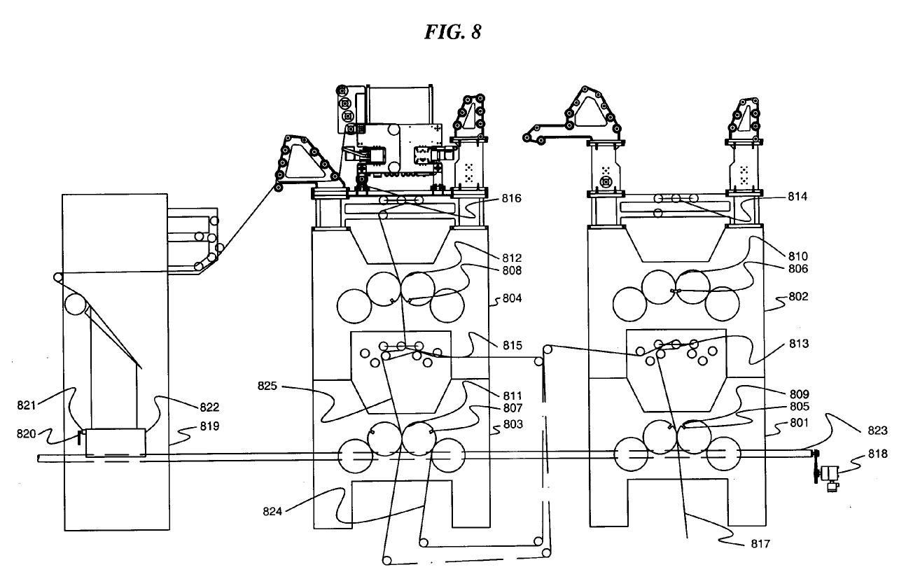

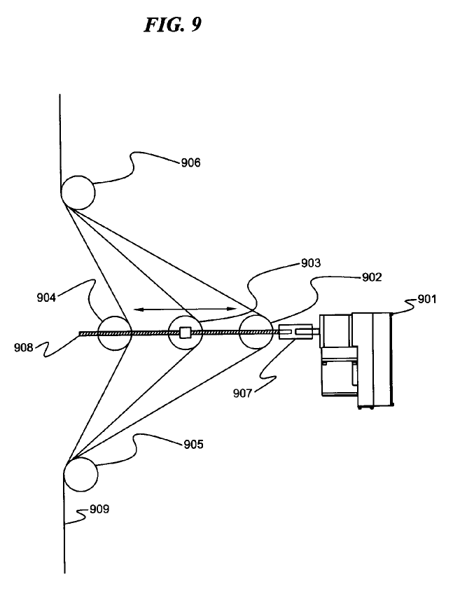

3) Each compensator 207, 307 (detail FIG. 9) is profiled using a string encoder and computerized measurement system to provide an accurate compensator position vs. linear distance to the next color cylinder (FIGS. 6,7). This may require the installation of an encoder or timing mechanism of some sort to provide an accurate indication of compensator position.

4) A computer 124 and associated interface hardware provide a means of calculating and storing the correct phase relationships of each of the color cylinders to the drive shaft 123.

Next the press is brought into register manually. When in register the phase relationships of the color cylinders to the drive shaft 123 are calculated and stored along with the compensator positions. The phase relationships of the color cylinders to the drive shaft are determined in the following manner: the encoder count position on the drive shaft is memorized at the instant of the pulse from each proximity sensor on the color cylinders (shown as pulse train S1 312 on FIG. 3A). The encoder count on the drive shaft (shown and pulse train A 310 in FIG. 3A) is periodic and absolute using the index pulse from the encoder (shown and pulse train Z 311 in FIG. 3A). Additional accuracy is obtained by inter-encoder pulse timing so that the position of a proximity sensor pulse can be accurately measured on an encoder sub-pulse level. As a result of this phase and compensator position measurement operation, the web distances between adjacent color print cylinders is known for the press being in register for a particular print job.

After a web path change for a previously stored in-register job, it is only necessary to turn the press over one revolution so that new phase measurements can be made on all color proximity sensor inputs. Web path changes may be due web breakage, ink change, malfunction, the need to run an intervening job, and the like. Such changes will be called ‘disturbances’ in this specification. Using the compensator profile curves to change the web distance between adjacent colors and the folder, the relative phase differences and therefore the web distances between color cylinders and folder are duplicated resulting in an in-register job.

### III. Detailed Description of Hardware

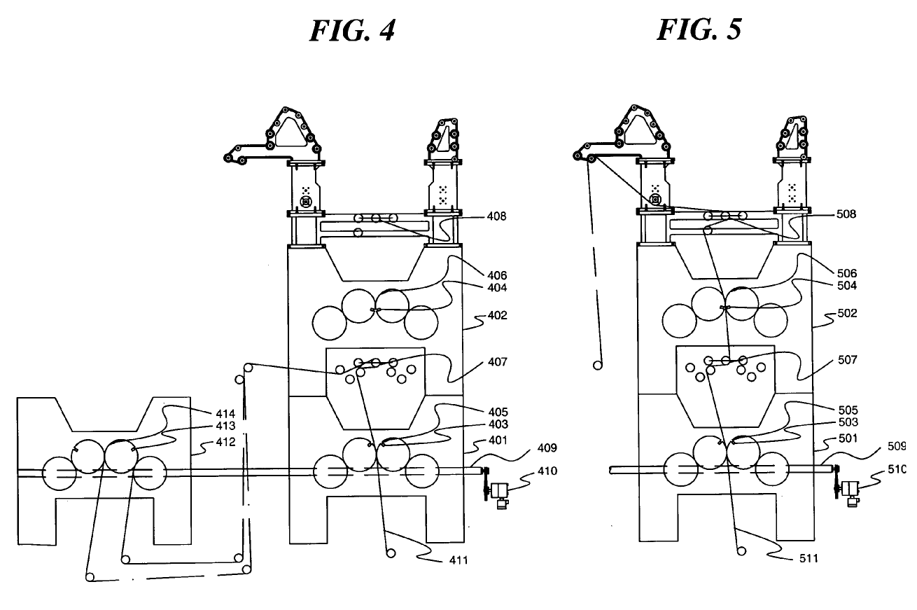

Turning to the embodiment shown in FIGS. 4 and 5, the following press interfaces must be added:
1. a) Press Encoder—shown in FIGS. 4 and 5 as 410, 510 the press encoder must be mounted to the drive shaft 409, 509 to provide a pulse train to count position. In addition, an index pulse must be mounted to provide a one pulse per revolution of the base operation—in the case of the newspaper example above—a proximity sensor 414 mounted on the folder would provide the required index pulse. This encoder/index pulse addition would provide a count per repeat that would provide an accurate count position within the periodic operation. If the linear distance of the periodic operation is known (in this case the repeat length of the print operation) then the count will provide an accurate distance position within the printed repeat.
1. b) Color Cylinder proximity sensors—each color cylinder must have a proximity sensor 405, 406, 505, 506 mounted to it so as to provide a single index pulse per revolution of the cylinder. As the color cylinder is necessarily periodic with the overall base operation (the folder in this newspaper example) the relative position of each color cylinder index pulse will fall in the same position of the press encoder/index count.
1. c) Compensator position sensor—all compensators 407, 408, 507, 508 must be outfitted with some means to determine their position. FIG. 9 illustrates a web compenstor in 3 different positions 902, 903, 904 with web supporting cylinders 905, 906, mounted to a motor driven screw 908 with encoder 901.
1. d) A personal computer 124 with interface hardware (not shown) must be added to accurately measure and store (on a job basis) the relative phase relationships between all color cylinders and the base operation and compensator positions. In the case of the above newspaper press example, the PC interface hardware must be capable of handling inputs of one standard encoder with index for the press encoder, four proximity sensor inputs for the four color cylinders (in the perfecting example we are using, top and bottom color cylinders are geared together for the purposes of this specification), and four encoder inputs with index for each of the four compensators to measure compensator position.

### IV. Detailed Description of Setup

The one operation that must be performed prior to operation is compensator position profiling. Web compensators 407, 408, 507, 508 work by increasing or decreasing the web path between adjacent print operations. Compensator profiling results in a curve of compensator position versus web length between print operations. Additionally, compensators can be inserted (webbed) between print operations in different ways depending on the type of operation to be performed. How a compensator is inserted between its adjacent print operations directly affects the compensator profile curve. Thus a profile curve must be generated for each compensator and each possible way that compensator can be inserted between its adjacent print operations.

In the example of the newspaper press, compensator profiling entails using a string encoder and measuring the distances between adjacent print operations through the intervening compensator while the compensator is run from one extreme of its travel to the other. This procedure can be automated and must be performed for every different instance of compensator insertion between adjacent print operations.

This is illustrated in FIGS. 6 and 7 where the string encoder is routed through the color unit in different ways to reflect two different web paths. In FIG. 6, only the lower print cylinders are being used (printing both sides of the web—known as perfecting). In FIG. 7 the color unit is printing two colors on each side of the web, thus the web is routed through both print cylinder pairs.

The results of compensator profiling are a table of compensator position versus distance between adjacent print operations for each instance of compensator insertion between the print operations.

Turning to FIG. 9, details of how compensator position 902, 903, 904 mounted on a screw 908 changes the alignment of the web 909.

### V. Detailed Description of Operation

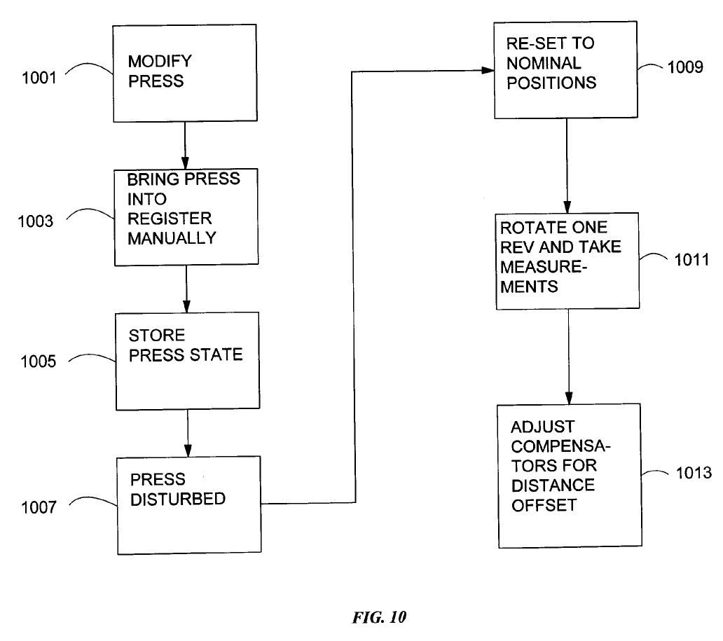

Turning to FIG. 10, the process starts by providing a press having the apparatus described above 1001. Then, the press must be brought into manual register 1003 at which time the phase positions of all color cylinders and compensator positions are stored. This press state is stored for this particular job 1005. For some reason, the press setup becomes disturbed 1007.

At some later date when this job is run again, the phase and compensator positions are recalled. From the phase angle difference between the adjacent print operations a distance offset is calculated. From the compensator profile curve for this recalled job and stored compensator position, the linear distance between adjacent print operations is calculated. This value is combined with the distance offset from the phase angle difference calculation to provide an overall distance value between the adjacent print operations. Next, the press is setup to run the new job by positioning compensators to their nominal position 1009, re-phasing the color cylinders for the new job, and rerouting the web through the machine for the new job. Then the press is run for a minimum of one revolution 1011 so that the new phase offsets of the color cylinders relative to the drive shaft and folder (in the example of the newspaper press above) can be determined. From these measurements the current phase angle differences between adjacent print operations is calculated resulting in current distance offset measurement between adjacent print operations 1013. This distance is combined with the current compensator position profile curve distance and compared with the stored value. For the press to be in register, the difference should be zero. If not, the compensator is moved (utilizing the profile curve) to make the difference zero.

Another embodiment of the method of the present invention is a technique whereby one can get finer resolution than possible using only encoder tooth pulses. One can do this by counting a high frequency (fixed frequency) pulse between adjacent teeth and relating that to velocity, giving us intra-tooth measurement accuracy. This turns out to be necessary to get the register as close as possible as tooth accuracy alone may not be sufficient.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A method of reregistering a press job after disturbing the setup comprising the steps of:
modifying a press;
bringing the press into register manually;
storing the press state;
resetting the press to nominal positions after the press is disturbed;
rotating the press one revolution and recording measurements;
adjusting web compensators for the offset between the stored press state and recorded measurements, thereby placing the press in register.

2. The method of claim 1, the step of modifying a press comprising the steps of:
providing an encoder attachable to a press drive shaft, the encoder providing a nominal resolution of 4096 pulses per revolution and an index pulse of one pulse per revolution;
providing a proximity sensor for each color cylinder in the press attachable to the color cylinder, the proximity sensor capable of providing one pulse per revolution;
profiling each web compensator on the press with a string encoder and computerized measurement system to provide an accurate web compensator position versus linear distance to the next color cylinder relationship; and
providing a computer having interface hardware with the encoder and sensors having a means for calculating and storing the correct phase relationships of each of the color cylinders to the drive shaft.

3. The method of claim 2, the step of storing the press state comprising the steps of:
calculating the phase relationships of the color cylinders to the drive shaft;
storing the phase relationships to the computer; and
storing the compensator positions to the computer.

4. The method of claim 3, the step of calculating the phase relationships comprising the steps of:
memorizing the encoder count position on the drive shaft at the instant of the pulse from each proximity sensor on the color cylinders;
memorizing inter-encoder pulse timing; and
calculating the phase relationships with the computer.

5. The method of claim 2, the step of profiling each web compensator comprising the steps of:
measuring the distances between adjacent print operations through an intervening compensator while the compensator is run from one extreme of its travel to the other; and
calculating tables of compensator position versus distance between adjacent print operations for each possible instance of compensator insertion between print operations.

6. The method of claim 1, further comprising the steps of:
rephasing the color cylinders after resetting to nominal positions; and
rerouting a web through the press before rotating one revolution.

7. The method of claim 1, further comprising the step of calculating the current phase angle differences between adjacent print operations after rotating for one revolution.

8. The method of claim 7, further comprising the step of calculating the current distance offset measurement between adjacent print operations from the phase angle differences.

9. The method of claim 8, further comprising the step of comparing the calculated distance offset measurement with the stored value from the position profile curve.

10. The method of claim 4 further comprising the steps of
counting a high frequency pulse between adjacent teeth; and
relating the count to web velocity, thereby improving intera-tooth measurement accuracy.

11. A method of reregistering a press job after disturbing the setup comprising the steps of:
recalling phase and compensator positions previously stored for the job;
positioning compensators to their nominal position;
re-phasing the press color cylinders for the job;
rerouting a web through the press for the job;
determining new phase offsets by running the press for a minimum of one revolution; and
comparing a distance offset between adjacent print operations, thereby confirming the distance difference is zero from the originally stored job and the press is back in register for the job.

12. An apparatus for reregistering a color press job after disturbing the setup comprising:
a press encoder able to be coupled to a drive shaft adapted to provide a pulse train to count position;
a color cylinder proximity sensor able to be coupled to each color cylinder to provide a single index pulse per revolution of the cylinders;
a compensator position sensor; and
a computer able to be operatively coupled to each encoder, sensor, and compensator.

13. The apparatus of claim 12 further comprising a proximity sensor able to be coupled with a folder for proving an index pulse used in calculating a count position within a periodic operation.

14. The apparatus of claim 12, the compensator position sensor comprising an encoder able to be coupled with a web compensator screw.

15. The apparatus of claim 12, the computer comprising interface hardware for coupling the computer to each encoder and proximity sensor.
